(19) United States
(12) Patent Application Publication
(10) Pub. No.: US 2015/0088513 A1
(43) Pub. Date: Mar. 26, 2015

(54) SOUND PROCESSING SYSTEM AND RELATED METHOD

(71) Applicant: HON HAI PRECISION INDUSTRY CO., LTD., New Taipei (TW)

(72) Inventors: HAI-HSING LIN, New Taipei (TW); HSIN-TSUNG TUNG, New Taipei (TW)

(21) Appl. No.: 14/488,800

(22) Filed: Sep. 17, 2014

(30) Foreign Application Priority Data
Sep. 23, 2013 (TW) 102134142

(51) Int. Cl. G10L 17/00

(52) U.S. Cl. CPC G10L 17/00
USPC 704/246

(57) ABSTRACT

A sound processing system is provided and is executed by a processor. The processor acquires a video/audio file from video/audio files. The processor controls a video/audio processing chip to build a voiceprint feature model of each section for use in speaker recognition, and to identify the speaker of each section based on comparison of the built voiceprint feature model of the acquired video/audio file and the voiceprint feature models of speakers stored in a storage unit. The processor generates a tag file recording relationships between the plurality of sections of the acquired video/audio file and the speakers according to the identification result. A sound processing method is also provided.

### CROSS-REFERENCE TO RELATED APPLICATIONS

This application claims priority to Taiwanese Patent Application No. 102134142 filed on Sep. 23, 2013 in the Taiwan Intellectual Property Office, the contents of which are incorporated by reference herein.

### FIELD

The present disclosure relates to processing systems, and particularly to a sound processing system and a method.

### BACKGROUND

It is inconvenient for users to search for a desired section from a number of stored video/audio files.

### BRIEF DESCRIPTION OF THE DRAWINGS

FIG. 1 illustrates a block diagram of an embodiment of a sound processing system.

FIG. 2 shows a tag file including relationships between a number of sections of a video/audio file and speakers for the sections.

FIG. 3 shows an interface in which the speakers of a second section, a fourth section and a fifth section are recognized.

FIG. 4 shows an interface in which the speakers of a first section and a third section are recognized.

FIG. 5 shows an interface in which the speaker of a sixth section is recognized.

FIG. 6 is a flowchart of a method of processing video/audio files implemented by the sound processing system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Only one definition that apply throughout this disclosure will now be presented.

The term “comprising” means “including, but not necessarily limited to”; it specifically indicates open-ended inclusion or membership in a so-described combination, group, series and the like.

Embodiments of the present disclosure will be described with reference to the accompanying drawings.

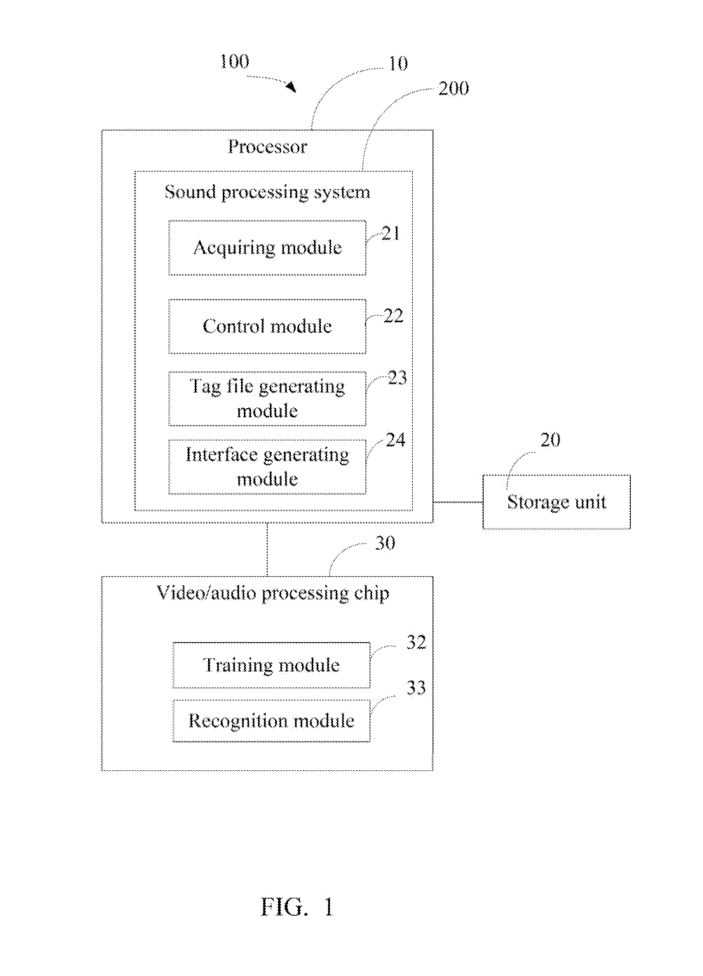

FIG. 1 illustrates an embodiment of a sound processing system 200 which is applied on a sound processing device 100. The sound processing device 100 includes a processor 10, a storage unit 20, and a video/audio processing chip 30. The sound processing system 200 includes a number of modules which are a collection of software instructions stored in the storage unit 20, and executed by the processor 10. The number of modules includes an acquiring module 21, a control module 22, a tag file generating module 23, and an interface generating module 24. The storage unit 20 stores a number of voiceprint feature models of speakers for use in speaker recognition, and a number of video/audio files. In at least one embodiment, the processor 10 can be a central processing unit, a digital signal processor, or a single chip, for example. In one embodiment, the storage unit 20 can be an internal storage system, such as a flash memory, a random access memory (RAM) for temporary storage of information, and/or a read-only memory (ROM) for permanent storage of information. The storage unit 20 can also be a storage system, such as a hard disk, a storage card, or a data storage medium. In at least one embodiment, the storage unit 20 can include two or more storage devices such that one storage device is a memory and the other storage device is a hard drive.

The acquiring module 21 acquires a video/audio file from a number of video/audio files in response to a selection operation. In another embodiment, once a user uploads a video/audio file, the acquiring module 21 automatically acquires the video/audio file. In at least one embodiment, each video/audio file is divided into a number of sections. In this embodiment, each video/audio file is divided into a number of sections by Bayesian Information Criterion (BIC) change detection.

The control module 22 controls the video/audio processing chip 30 to build a voiceprint feature model of each section for use in speaker recognition, and to identify the speaker of each section based on the comparison of the built voiceprint feature model of each section and the voiceprint feature models of speakers stored in the storage unit 20.

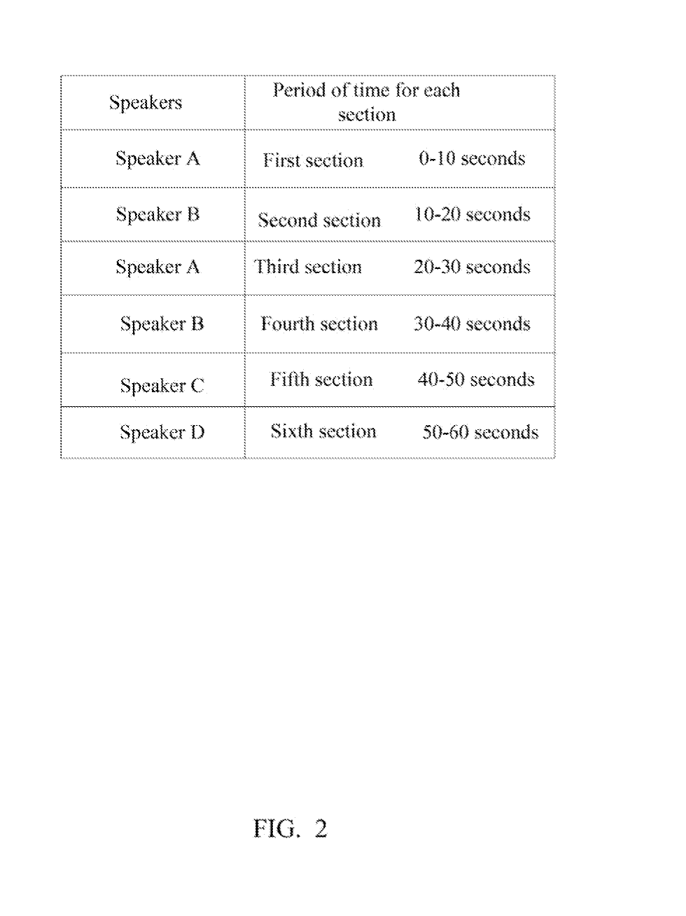

As shown in FIG. 2, the tag file generating module 23 generates a tag file recording relationships between the number of sections of the acquired video/audio file and the speakers according to the identification result generated by the video/audio processing chip 30. Each section corresponds to one speaker.

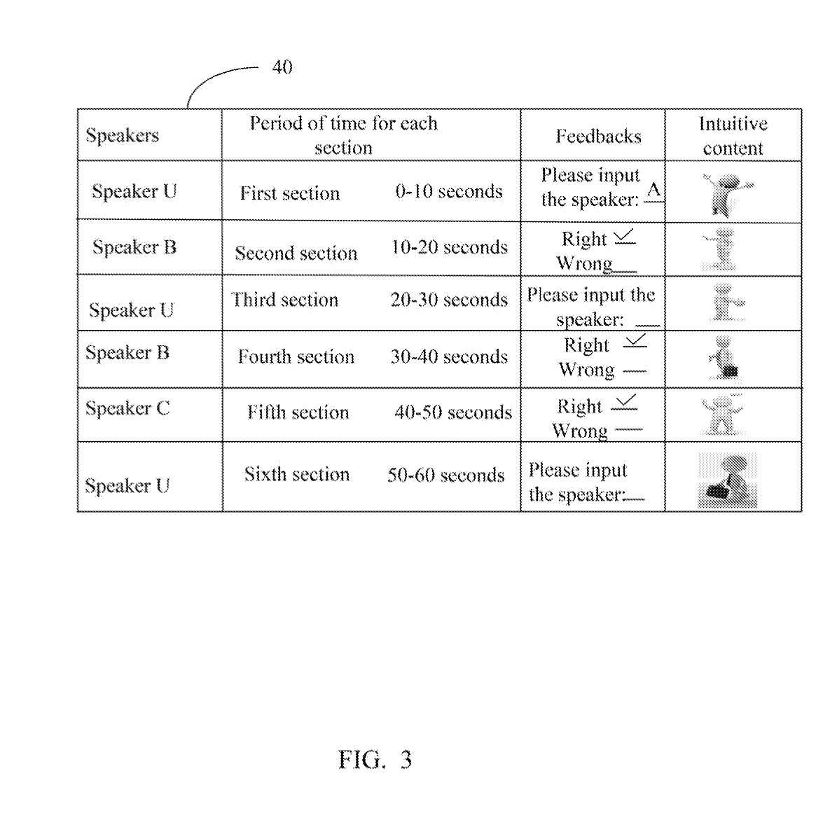

As shown in FIG. 3, the interface generating module 24 generates an interface 40 displaying the relationships in the tag file and including a feedback column for the user to input feedbacks. The feedbacks are used for updating the relationships recorded in the tag file. The feedbacks include the input speakers for one or more sections with unknown speakers and user's confirmation for the speakers for one or more sections with recognized speakers. In one embodiment, the interface 40 may further display intuitive content corresponding to each section for confirming the speaker of each section. If the acquired file is a video file, the content may be a static image including the speaker of each section or a short video of each section. The user can confirm the speaker of each section by directly viewing the static image or by clicking the short video of each section. If the acquired file is an audio file, the content may be a short audio (e.g., 2 seconds) of each section. When one short audio of one section is clicked, the short audio is played, and the user can confirm the speaker of the section by listening to the short audio.

In this embodiment, when the user inputs one speaker through the interface 40 as a feedback for one section with the unknown speaker, the control module 22 further controls the video/audio processing chip 30 to recognize the built voiceprint feature model of the section as the voiceprint feature model of the input speaker, and identify the speaker of each of the other sections with unknown speakers based on the comparison of the built voiceprint feature model of each of the other sections with unknown speakers and the voiceprint feature model of the input speaker. In this embodiment, for each section with one recognized speaker, a right option and a wrong option are displayed in the feedback column. The right option is checked by default, which indicates that when the speaker of one section is recognized by the system 200, the system 200 automatically determines that the recognition result is right without user's interaction. If the user determines that the recognition result corresponding to one section is wrong, the wrong option can be selected by the user, and the system 200 will determine the speaker of the section again. When the wrong option of one section with one recognized speaker is selected, the interface generating module 24 refreshes the interface 40 to replace the recognized speaker of the selected section with the unknown speaker, and prompt the user to input a right speaker for the section, e.g., display the words of “please input the speaker” in the feedback column. In an alternative embodiment, for each section with one recognized speaker, only the wrong option is displayed in the feedback column, and the system 200 automatically determines that the recognition result of one section with one recognized speaker is right if the wrong option corresponding to the section is not selected.

Supposed, there is a video file the length of which is 1 minutes and the video file is divided into six sections: a first section from 0 to 10 seconds in which the speaker A speaks, a second section from 10 to 20 seconds in which the speaker B speaks, a third section from 20 to 30 seconds in which the speaker A speaks, a fourth section from 30 to 40 seconds in which the speaker B speaks, a fifth section from 40 to 50 seconds in which the speaker C speaks, and a sixth section from 50 to 60 seconds in which the speaker D speaks. The acquiring module 21 acquires the selected video file, the control module 22 controls the video/audio processing chip 30 to generate the voiceprint feature model of each above mentioned section to determine the speaker of each section. Supposed, the storage unit 20 stores the voiceprint feature models of the speakers B and C, and the voiceprint feature models of the speakers A and D are absent from the storage unit 20. The video/audio processing chip 30 determines that the speaker of the second section is the speaker B, the speaker of the fourth section is the speaker B, and the speaker of the fifth section is the speaker C. The video/audio processing chip 30 also determines that the speakers of the first section, the third section, and the sixth section are unknown. The tag file generating module 23 generates a tag file which records the relationship between a speaker U and the first section (0-10 seconds), the relationship between the speaker B and the second section (10-20 seconds), the relationship between the speaker U and the third section (20-30 seconds), the relationship between the speaker B and the fourth section (30-40 seconds), the relationship between the speaker C and the fifth section (40-50 seconds), and the relationship between the speaker U and the sixth section (50-60 seconds). The speaker U represents an unknown speaker. The interface generating module 24 generates the interface 40 displaying the relationships of the above tag file and including a feedback column for the user to input feedbacks. The feedbacks include the input speakers and user's confirmation for the speakers recognized by the video/audio processing chip 30.

From the interface 40 the user knows that the speakers of the first section, the third section, and the sixth section are unknown speakers, and knows that the speakers of the first section and the third section are the speaker A by viewing the displayed images corresponding to the first section, the third section, and the sixth section. The user then inputs the speaker A through the interface 40 as a feedback for the first section. In this embodiment, when the speaker A is input, the video/audio processing chip 30 recognizes the voiceprint feature model of the first section as the voiceprint feature model of the speaker A, determines that the speaker of the third section is the speaker A according to the comparison of the built voiceprint feature model of the third section and the voiceprint feature model of the speaker A, and determines that the speaker of the sixth section is the speaker U according to the comparison of the built voiceprint feature model of the sixth section and the voiceprint feature model of the speaker A, After the speakers of the first section, the third section, and the sixth section are checked, the relationships in the tag file are correspondingly updated and the content of the interface 40 is refreshed.

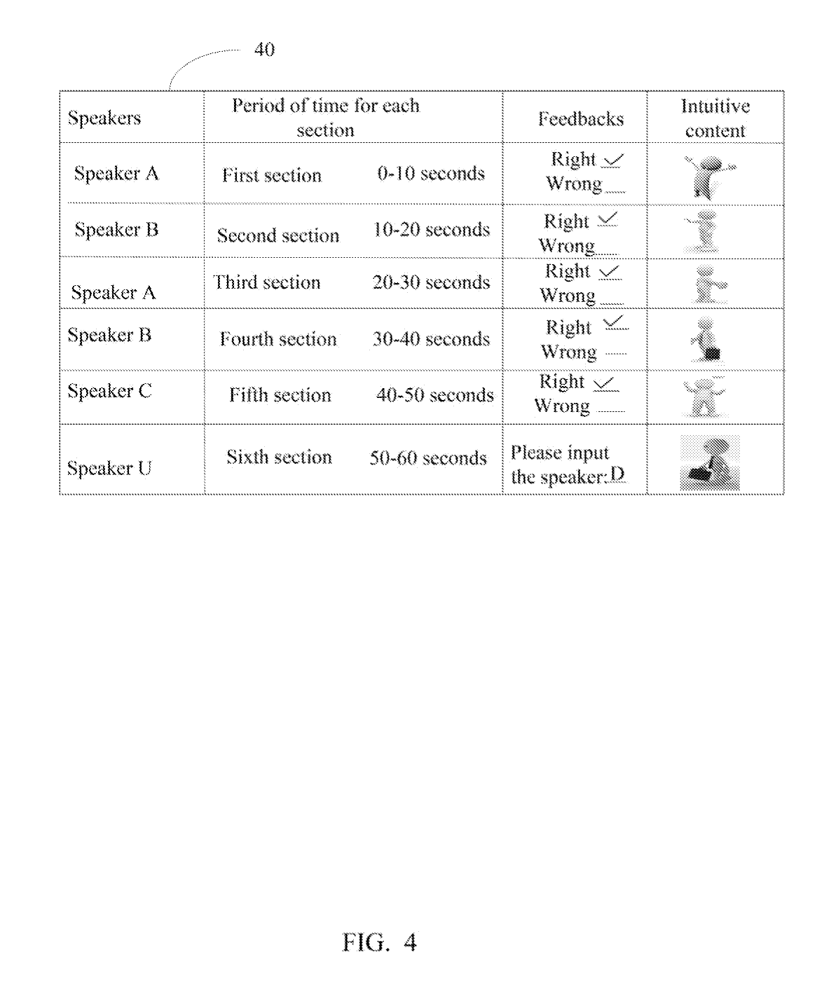

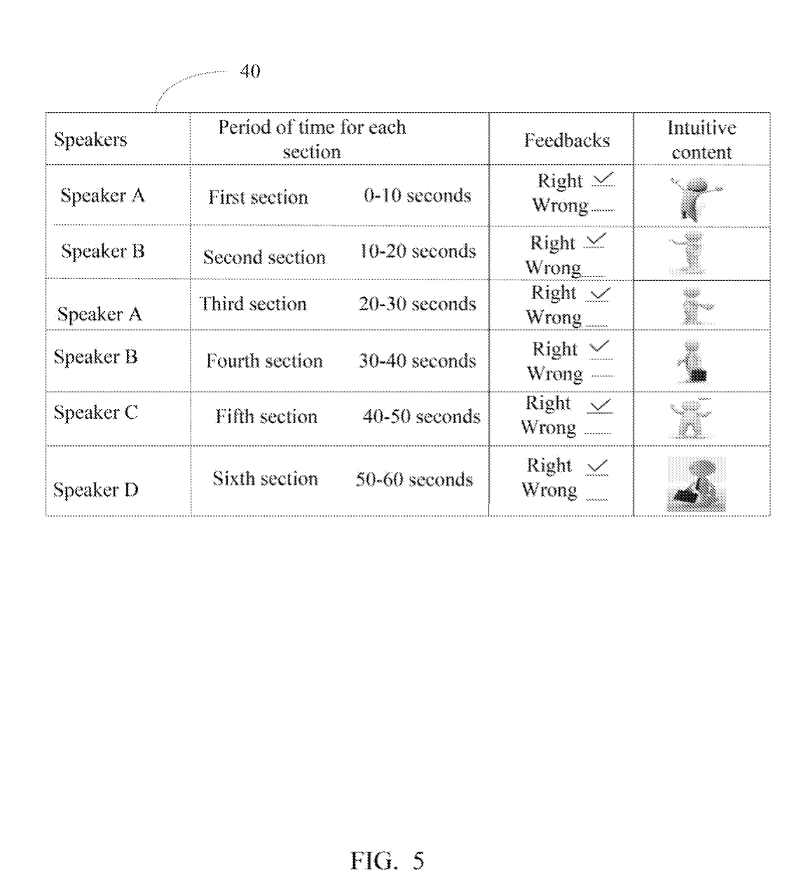

As shown in FIG. 4, from the refreshed interface 40, the user knows that the speaker of the sixth section is still unknown, and knows that the speaker of the sixth section is the speaker D by viewing the displayed image corresponding to the sixth section, the user then input the speaker D through the interface 40 as a feedback for the sixth section. When the speaker D is input, the video/audio processing chip 30 recognizes the built voiceprint feature model of the sixth section as the voiceprint feature model of the speaker D, and determines that the speaker of the sixth section is the speaker D. As shown in FIG. 5, after the speaker of the sixth section is recognized, the relationships between the tag file is correspondingly updated and the content of the interface 40 is correspondingly refreshed. At this time, all the speakers in the selected video file are recognized.

The video/audio processing chip 30 includes a training module 32 and a recognition module 33. The training module 32 executes an initial training phase in which voice samples of the speaker of each section are collected, features are extracted, and the voiceprint feature model for use in speaker recognition is built from the extracted features. The recognition module 33 identifies the speaker of each section based on a comparison between the built voiceprint feature model and the voiceprint feature models of the speakers stored in the storage unit 20.

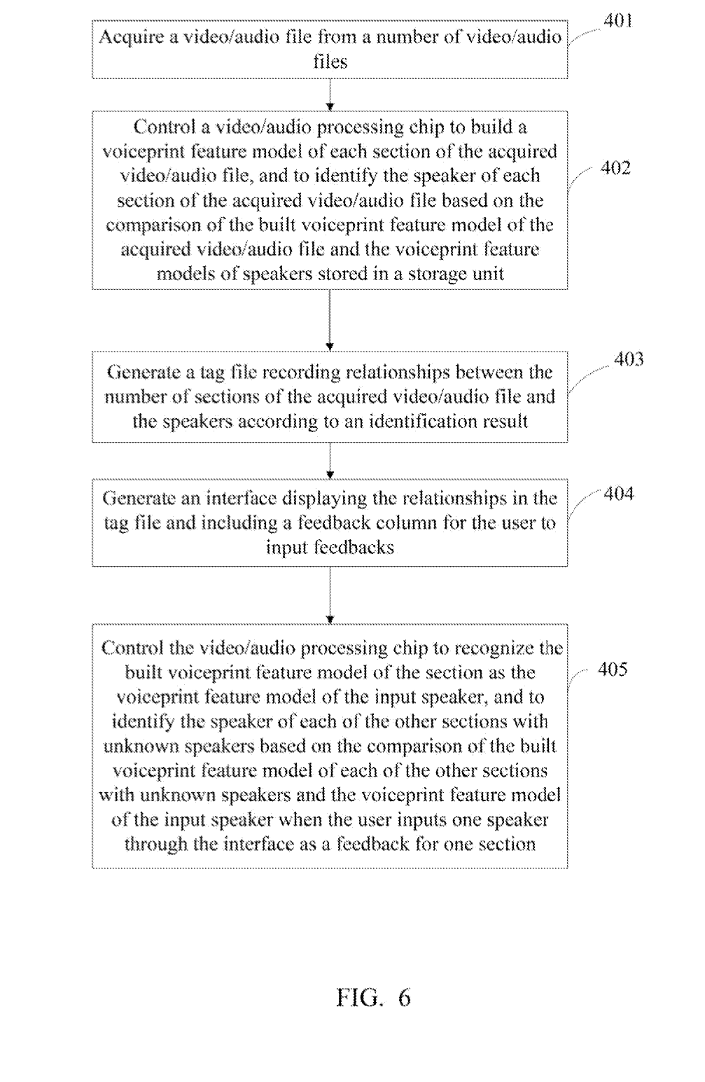

FIG. 6 is a flowchart of a method of processing videos/audios implemented by the sound processing system of FIG. 1.

In block 401, an acquiring module acquires a video/audio file from a number of video/audio files stored in a storage unit.

In block 402, a control module controls a video/audio processing chip to build a voiceprint feature model of each section for use in speaker recognition, and to identify the speaker of each section based on the comparison of the built voiceprint feature model of each section and the voiceprint feature models of speakers stored in the storage unit.

In block 403, a tag file generating module generates a tag file recording relationships between the number of sections of the acquired video/audio file and the speakers according to the identification result generated by the video/audio processing chip.

In block 404, an interface generating module generates an interface displaying the relationships in the tag file and including a feedback column for the user to input feedbacks.

In block 405, when the user inputs one speaker through the interface as a feedback for one section with the unknown speaker, the control module further controls the video/audio processing chip to recognize the built voiceprint feature model of the section as the voiceprint feature model of the input speaker, and to identify the speaker of each of the other sections with unknown speakers based on the comparison of the built voiceprint feature model of each of the other sections with unknown speakers and the voiceprint feature model of the input speaker.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A sound processing system comprising:
a storage unit configured to store a plurality of voiceprint feature models of speakers for use in speaker recognition, and a plurality of video/audio files, each of the plurality of video/audio files being divided into a plurality of sections;
a video/audio processing chip;
a processor; and
a plurality of modules which, when executed by the processor to cause the processor to:
acquire a video/audio file from the plurality of video/audio files;
control the video/audio processing chip to build a voiceprint feature model of each section of the acquired video/audio file, and to identify the speaker of each section of the acquired video/audio file based on the comparison of the built voiceprint feature model of the acquired video/audio file and the voiceprint feature models of speakers stored in the storage unit; and
generate a tag file recording relationships between the plurality of sections of the acquired video/audio file and the speakers according to the identification result.

2. The sound processing system as described in claim 1, wherein the processor is further configured to display an interface displaying the relationships in the tag file and displaying a feedback column for the user to input feedbacks for updating the relationships recorded in the tag file, the feedbacks comprises input speakers for one or more sections with unknown speakers, when the user inputs one speaker through the interface as a feedback for one section with the unknown speaker, the processor is further configured to control the video/audio processing chip to recognize the built voiceprint feature model of the section with the unknown speaker as the voiceprint feature model of the input speaker.

3. The sound processing system as described in claim 2, wherein the feedbacks further comprises user's confirmation for the speakers for one or more sections with recognized speakers.

4. The sound processing system as described in claim 3, wherein for each section with one recognized speaker, a wrong option is displayed in the feedback column and the wrong option is selectable, the processor is further configured to determine the speaker of one section again when the wrong option corresponding to the section is selected.

5. The sound processing system as described in claim 4, wherein when the wrong option of one section with one recognized speaker is selected, the processor is further configured to refresh the interface to replace the recognized speaker of the selected section with the unknown speaker, and prompt the user to input a right speaker for the section.

6. The sound processing system as described in claim 2, wherein the interface further displays intuitive content corresponding to each section of the acquired video/audio file for confirming the speaker of each section.

7. A sound processing method implemented by a sound processing device comprising a storage unit configured to store a plurality of voiceprint feature models of speakers for use in speaker recognition, and a plurality of video/audio files, the sound processing device further comprising a video/audio processing chip, the method comprising:
acquiring a video/audio file from the plurality of video/audio files;
controlling the video/audio processing chip to build a voiceprint feature model of each section of the acquired video/audio file, and to identify the speaker of each section of the acquired video/audio file based on the comparison of the built voiceprint feature model of the acquired video/audio file and the voiceprint feature models of speakers stored in the storage unit; and
generating a tag file recording relationships between the plurality of sections of the acquired video/audio file and the speakers according to the identification result.

8. The sound processing method as described in claim 7, further comprising:
displaying an interface displaying the relationships in the tag file and displaying a feedback column for the user to input feedbacks for updating the relationships recorded in the tag file, the feedbacks comprising input speakers for one or more sections with unknown speakers; and
controlling the video/audio processing chip to recognize the built voiceprint feature model of one section with the unknown speaker as the voiceprint feature model of one input speaker corresponding to the section.

9. The sound processing method as described in claim 8, wherein the feedbacks further comprises user's confirmation for the speakers for one or more sections with recognized speakers, for each section with one recognized speaker, a wrong option is displayed in the feedback column and the wrong option is selectable, the method further comprises:
determining the speaker of one section again when the wrong option corresponding to the section is selected.

10. The sound processing method as described in claim 9, wherein “determining the speaker of one section again when the wrong option corresponding to the section is selected” comprises:
refreshing the interface to replace the recognized speaker of the selected section with the unknown speaker, and prompting the user to input a right speaker for the section when the wrong option of one section with one recognized speaker is selected.

11. The sound processing method as described in claim 8, wherein the interface further displays intuitive content corresponding to each section of the acquired video/audio file for confirming the speaker of each section.

12. A non-transitory storage medium having stored thereon instructions that, when executed by at least one processor of a sound processing device, causes the least one processor to execute instructions of a method for automatically processing a sound of a video/audio file, the method comprising:
acquiring a video/audio file from a plurality of video/audio files, the video/audio file being divided into a plurality of sections;
controlling a video/audio processing chip to build a voiceprint feature model of each section of the acquired video/audio file, and to identify the speaker of each section of the acquired video/audio file based on the comparison of the built voiceprint feature model of the acquired video/audio file and the voiceprint feature models of speakers stored in a storage unit; and
generating a tag file recording relationships between the plurality of sections of the acquired video/audio file and the speakers according to the identification result.

13. The non-transitory storage medium as described in claim 12, further comprising:
displaying an interface displaying the relationships in the tag file and displaying a feedback column for the user to input feedbacks for updating the relationships recorded in the tag file, the feedbacks comprising input speakers for one or more sections with unknown speakers; and
controlling the video/audio processing chip to recognize the built voiceprint feature model of one section with the unknown speaker as the voiceprint feature model of one input speaker corresponding to the section.

14. The non-transitory storage medium as described in claim 13, wherein the feedbacks further comprises user's confirmation for the speakers for one or more sections with recognized speakers, for each section with one recognized speaker, a wrong option is displayed in the feedback column and the wrong option is selectable, the method further comprises:
determining the speaker of one section again when the wrong option corresponding to the section is selected.

15. The non-transitory storage medium as described in claim 13, wherein “determining the speaker of one section again when the wrong option corresponding to the section is selected” comprises:
refreshing the interface to replace the recognized speaker of the selected section with the unknown speaker, and prompting the user to input a right speaker for the section when the wrong option of one section with one recognized speaker is selected.

16. The non-transitory storage medium as described in claim 13, wherein the interface further displays intuitive content corresponding to each section of the acquired video/audio file for confirming the speaker of each section.
